(19) United States
(12) Patent Application Publication
(10) Pub. No.: US 2024/0033821 A1
(43) Pub. Date: Feb. 1, 2024

(54) THREE DIMENSIONAL PRINTING WITH COMPOSITE METAL MATERIALS

(71) Applicant: MATS MOOSBERG, Torslanda (SE)

(72) Inventor: MATS MOOSBERG, Torslanda (SE)

(73) Assignee: Mats Moosberg, Torslanda (SE)

(21) Appl. No.: 18/210,661

(22) Filed: Jun. 16, 2023

Related U.S. Application Data
(60) Provisional application No. 63/353,065, filed on Jun. 17, 2022.

(51) Int. Cl. B22F 7/00; B22F 12/53; B22F 12/13; B22F 10/80

(52) U.S. Cl. CPC B22F 7/008; B22F 12/53; B22F 12/13; B22F 10/80; B33Y 30/00

(57) ABSTRACT

The present invention relates to a three-dimensional printer. Further, the present invention relates to a three dimensional printing using metal(s) and composite metal materials. A method for 3D printing object using composite metal materials, which is prepared by using at least two type of materials such as metal and metal alloys, is disclosed. The printed 3D object is heat treated after printing to convert composite metal materials to alloys of metals. The composite metal materials and 3D printer having a print head unit for supplying composite metal materials is also disclosed. The low temperature melting point material (LTM) and the high temperature melting point metal powder (HTMP) are used for preparing composite metal materials. The additive process can also be employed for manufacturing three dimensional objects is disclosed.

### CROSS REFERENCE TO RELATED APPLICATIONS

This application is a non-provisional application and claims the benefit under 35 U.S.C. 119 (e) of U.S. provisional application No. 63/353065 filed on Jun. 17, 2023 and hereby incorporated by reference in their entireties into this application

### FEDERALLY SPONSORED RESEARCH AND DEVELOPMENT

Not applicable.

### MICROFICHE

Not applicable

### (1) Field of the Invention

The present invention generally relates to the field of three dimensional printing. The invention, particularly relates to three dimensional printing using composite metal materials. A method for 3D printing object using composite metal materials, which is prepared by using at least two types of materials such as metal and metal alloys, is disclosed. The printed 3D object is heat treated after printing to convert composite metal materials to alloys of metals. The composite metal materials and 3D printer having a print head unit for supplying composite metal materials is also disclosed.

### (2) Background of the Invention

3D printers are used to build solid models by performing layer by layer printing of building material. The building material can be of the different forms, such as liquid, semiliquid at the 3D printhead, for example, a solid material can be heated and then extruded from a 3D printer nozzle. The layers of building materials can be solidified on a substrate. 3D printer systems can use a fused filament fabrication (FFF) process (sometimes called fused deposition modeling (FDM) process) in which a filament is moved by a filament moving mechanism, toward a heated zone. The filament can be melted, and extruded on a platform to form a 3D object. A commercially available FFF system uses a heated nozzle to extrude a melted material like a plastic wire. The starting material is in the form of a filament which is being supplied from a spool. The filament is introduced into a flow passage of the nozzle and is driven to move like a piston inside this flow passage. The front end, near the nozzle tip, of this piston is heated to become melted. The rear end or solid portion of this piston pushes the melted portion forward to exit through the nozzle tip. The nozzle is translated under the control of a computer system in accordance with previously generated CAD data sliced into constituent layers.

There are two main drivers of whether or not a metal alloy is printed today: printability and demand. Though there are a wide variety of metal 3D printing processes out there, nearly all rely on metal powders. These materials take two forms in printing: raw 3D printing metal powders, or bound powder 3d printing metal filament. As a result, the metal materials printable today are to a large degree constrained by powder availability and whether or not that powder can be effectively bound. Aluminum, as an example, is notoriously difficult to print well and is as a result relatively uncommon. The metal alloy provides more strength, shock absorbency, toughness, isotropic strength, surface harness, wear resistance, and heat resistance. Because of this, the metal alloys or composite metals are used for 3D printing of the various machining tools and other delicate metallic parts which are important in many different applications.

A number of different types of compositions for three dimensional printing are available in prior art. For example, the following patents are provided for their supportive teachings and are all incorporated by reference: U.S. Pat. No. 5,121,329 discloses an apparatus for making three-dimensional physical objects of a predetermined shape by sequentially depositing multiple layers of solidifying material on a base member in a desired pattern. The reference does not appear to disclose the 3D printing of composite metal materials.

Another prior art document, WO2017014457 discloses a 3D printer using a metal alloy filament, wherein the 3D printer introduces a metal alloy filament (650) through a nozzle (610) formed inside an induction heating coil (620), melts and extrudes the filament, and laminates the filament three-dimensionally inside a chamber (500) heated to a similar temperature. The present invention forcibly introduces a metal alloy filament in a nozzle, heated by an induction heating coil which circularly encloses the exterior of the nozzle and forms a cooling passage therein, by means of a transfer gear connected to a transfer motor. A 3D printer for a metal alloy filament is provided in which, in order to prevent the oxidation of a metal alloy laminate (520), an inert gas is introduced, the outside and heat and air are blocked, and a metal alloy filament (650) that is melted in a nozzle and extruded is laminated one layer at a time on a floor plate (510) installed inside a heated chamber (500) and moving three-dimensionally with respect to the nozzle, in order to firmly attach the filament having little deformation. The reference appear to disclose the 3D printing method of metal alloy filament having a step of heating the metal alloy filament in the nozzle.

Another prior art document, US20170282283A discloses an apparatus for the layer-by-layer fabrication of a three-dimensional metallic structure from particles formed by melting a metal wire. The apparatus includes or consists essentially of an electrically conductive base for supporting the structure during fabrication, a wire-feeding mechanism for dispensing wire over the base, one or more mechanical actuators for controlling a relative position of the base and the wire-feeding mechanism, a power supply for applying a current between the wire and the base sufficient to cause the wire to release a metal particle (e.g., via heat arising from contact resistance between the wire and an object in contact therewith, e.g., the base), and circuitry for controlling the one or more actuators and the power supply to create the three-dimensional metallic structure on the base from successively released metal particles. The reference does not appear to disclose the 3D printing of composite metal materials.

Yet another prior art document, EP2359962A2 discloses a method for producing a cast component comprises forming a free form fabricated thin shell ceramic casting mold with an integrally formed casting core and having a molten metal receiving cavity, the casting core extending into the molten metal receiving cavity to form at least one opening in the cast component Molten metal is poured into the molten metal receiving cavity without providing additional mechanical support to the thin shell ceramic casting mold. The molten metal is solidified within the molten metal receiving cavity and around the integral casting core. The reference does not appear to disclose the 3D printing of composite metal materials.

Yet another prior art document, CN105291436A discloses a double-wire printing head of a 3D printer and a switching control method of the double-wire printing head. The technical problem that when an existing double-wire printing head carries out printing, two printing heads interfere with each other is solved. The double-wire printing head comprises a wire feeding device and two printing head bodies. The wire feeding device comprises a wire feeding mechanism and a switching mechanism.

The wire feeding mechanism comprises a wire guiding pipe base, a left wire feeding pressing wheel, a right wire feeding pressing wheel, a drive wire feeding wheel, a wire guiding pipe, a fixing plate, a pre-tightening spring and a wire feeding motor. The switching mechanism comprises a rotating plate, a switching connecting rod, a push rod and two pressing wheel swing arms. However, this prior art does not appear to disclose the 3D printing of composite metal materials.

Yet another prior art document, WO2018122390A1 discloses a filament feeding mechanism for a 3D printer head for selectively feeding filaments, comprising a motor wheel for feeding filaments, and a set of pinch rollers mounted on a rocker arm. It further comprises a pushrod connected to the rocker arm, and in that the rocker arm is pivotably mounted with the axis of rotation and adopted to rotate by lateral motion of pushrod to press one of the pinch rollers to the respective filament. However, this prior art does not appear to disclose the 3D printing of composite metal materials using filament technology.

Yet another prior art document, WO2007130229A2 discloses an extrusion head comprising at least one drive wheel and an assembly positionable between at least a first state and a second state. The assembly comprises a first extrusion line configured to engage the at least one drive wheel while the assembly is positioned in the first state, and a second extrusion line configured to engage the at least one drive wheel while the assembly is positioned in the second state. However, this prior art document does not appear to discuss a three-dimensional printer with composite metal materials.

Yet another prior art document, U.S. Pat. No. 8,827,684B1 discloses a fused filament fabrication printer has a fixed extrusion module having multiple printheads having print tips. The fixed arrangement of the printing heads allows the close spacing of multiple print tips in a printhead unit, and the simple routing of multiple plastic or metal filaments to the individual printing heads. The closely spaced print tips in the printhead unit share common components. An exemplary printhead unit has four printing heads which share a common heating block and beating block temperature sensor. However, this prior ant document does not appear to discuss a three-dimensional printer with composite metal materials.

Yet another prior art document, CN111390193 discloses satellite-free high-sphericity 3D printing additive manufacturing metal powder and equipment thereof. The patent application adopted a vacuum inert gas atomization method of ‘circular airflow wall anti-satellite ball’, firstly a vacuum intermediate frequency smelting furnace is adopted to melt metal materials, then supersonic gas is used to crush and cool the melted metal melt to prepare metal alloy powder with a certain particle size range, and under the auxiliary action of a ‘circular airflow wall anti-satellite ball’ device, the prepared 3D printing additive manufacturing metal alloy powder has the characteristics of high sphericity, less satellite balls, good fluidity and low oxygen content.

Yet another prior art document, WO2021035677 discloses a method for preparing an additively manufactured metal powder, comprising the following steps: decomposing a metal base powder into a metal alloy powder matrix by means of a mechanical grinding process; adding strengthening particles to the metal alloy powder matrix and mixing the metal alloy powder matrix and the reinforcing particles to obtain composite metal particles, said reinforcing particles being tantalum carbide or hafnium carbide, the size of the composite metal particles ranging from 15 microns to $3 microns; adding a binder, and binding together the metal alloy powder matrix and the reinforcing particles by means of a spray drying process using said binder to obtain dispersed particles; using a sintering process to remove the binder from the dispersed particles and thereby obtain an additively manufactured metal composite powder.

Yet another non-patent literature discloses a manufacturing technology that enables a constrained set of polymer-metal composite components. The prior art provides (1) free and open source hardware and (2) software for printing systems that achieves metal wire embedment into a polymer matrix 3D-printed part via a novel weaving and wrapping method using (3) OpenSCAD and parametric coding for customized g-code commands. Composite parts are evaluated from the technical viability of manufacturing and quality. The prior art shows that utilizing a multi-polymer head system for multi-component manufacturing reduces manufacturing time and reduces the embodied energy of manufacturing. However, this prior art document does not appear to discuss a three-dimensional printer with composite metal materials.

However, above mentioned references and many other similar references has one or more of the following shortcomings: (a) not disclosing 3D printing of metal(s) and composite metal materials; (b) complex structure of three-dimensional imaging apparatus (three-dimensional imaging apparatus (3D-printer)); (c) limited number of materials simultaneously can be used; (d) print head unit are bulkier and heavy; (e) only discloses polymer-metal composite; and (f) further there are also examples of 3d printer with polymer-metal composites.

The present application addresses the above mentioned concerns and short comings with regard to providing a method for 3D printing object using composite metal materials, which is prepared by using at least two type of materials such as metal and metal alloys.

### (3) SUMMARY OF THE INVENTION

In the view of the foregoing disadvantages inherent in the known types of for three dimensional printing now present in the prior art, the present invention provides a three-dimensional imaging apparatus for modeling with composite metal materials on a layer-by-layer basis in accordance with a computer aided design (CAD) image of an object. As such, the general purpose of the present invention, which will be described subsequently in greater detail, is to provide an innovative three-dimensional printer for printing a three-dimensional object using composite metal materials. which has all the advantages of the prior art and none of the disadvantages.

The main objective of the present invention is to provide a three-dimensional imaging apparatus for modeling with composite metal materials on a layer-by-layer basis in accordance with a computer aided design (CAD) image of an object, comprising: a printer holding frame; a gantry motion system; a supply of composite materials, wherein said supply of composite materials is configured to supply either a filament or a rod: a print head unit, wherein said print head unit is fixed on said gantry motion system; a nozzle; a build platform on which said object is printed; wherein said print head unit comprising a feeding arrangement, a beating arrangement, and a screw mechanism; wherein said feeding arrangement comprises a motor, a plurality of wheels, & a coupler: wherein said heating arrangement is configured to heat said composite metal materials at a temperature; wherein said screw mechanism comprises a material receiving screw geometry, a screw, a nozzle head; wherein said feeding arrangement is configured to feed either said filament or said rod to said screw mechanism while heating by said beating arrangement; and wherein said screw mechanism is configured to extrude said composite materials by said nozzle thru a nozzle bead for printing.

The another objective of the present invention is to provide a three-dimensional imaging apparatus for modeling with composite metal materials on a layer-by-layer basis in accordance with a computer aided design (CAD) image of the object, wherein said composite materials is made up of a low melting point material (LTM) and a high melting point powdered material (HTMP).

The another objective of the present invention is to provide a three-dimensional imaging apparatus for modeling with composite metal materials on a layer-by-layer basis in accordance with a computer aided design (CAD) image of the object, wherein said temperature is above the melting point of said low melting point material (LTM) but below the melting point of said high melting point powdered material (HTMP).

The another objective of the present invention is to provide a three-dimensional imaging apparatus for modeling with composite metal materials on a layer-by-layer basis in accordance with a computer aided design (CAD) image of the object, wherein said temperature is in the range of 100° C. to 1100° C.

The another objective of the present invention is to provide a three-dimensional imaging apparatus for modeling with composite metal materials on a layer-by-layer basis in accordance with a computer aided design (CAD) image of the object. wherein said screw is selected from the type of an auger screw or a cavity pump screw.

The another objective of the present invention is to provide a three-dimensional imaging apparatus for modeling with composite metal materials on a layer-by-layer basis in accordance with a computer aided design (CAD) image of the object, wherein said low melting point material (LTM) can be a pure metal or an alloy.

The another objective of the present invention is to provide a three-dimensional imaging apparatus for modeling with composite metal materials on a layer-by-layer basis in accordance with a computer aided design (CAD) image of the object, wherein said low melting point material (LTM) is selected from the group of Tin, Indium, Bismuth, Zinc, Lead, Cadmium, Thallium, Gallium, Antimony, Magnesium, Silicon, Aluminium, or an alloy of 2 or more of these metals.

The another objective of the present invention is to provide a three-dimensional imaging apparatus for modeling with composite metal materials on a layer-by-layer basis in accordance with a computer aided design (CAD) image of the object, wherein said high melting point powdered material (HTMP) can be a pure metal or an alloy.

The another objective of the present invention is to provide a three-dimensional imaging apparatus for modeling with composite metal materials on a layer-by-layer basis in accordance with a computer aided design (CAD) image of the object, wherein said high melting point powdered material (HTMP) is selected from the group of Copper, Iron, Silver, Gold, Titanium, Nickel, Aluminium, Zinc, Vanadium, Chromium, Cobalt, Zirconium, or an alloy between 2 or more of these metals.

The another main objective of the present invention is to provide a method for printing a three-dimensional object with composite metal materials, wherein said method comprising the following steps: (i) Preparing composite materials by mixing a high melting point powdered material (HTMP) and a low melting point material (LTM) at a mixing temperature above the melting point of said low melting point material (LTM) but below the melting point of said high melting point powdered material (HTMP) and extruding it to form a pellet, a filament, or a rod; (ii) Preloading said filament or said rod of composite metal materials, prepared in step (i), on a supply of composite materials; (iii) Creating an image of a three-dimensional object of composite metal materials by a computer aided design (CAD) tool: (iv) Preparing data for three dimensional printing by said slicer application or by said computer interface based on the information received from step (iii), (v) Communicating said data for said three dimensional printing object from said slicer application or by said computer interface to a three-dimensional printer; (vi) Printing a layer onto a build platform by extruding the heated said composite metal materials, wherein said composite metal materials is heated at temperature above the melting point of a low melting point material (LTM) but below the melting point of a high melting point powdered material (HTMP); and (vii) Repeating step (vi) for printing one layer of the said three-dimensional object by layer-by-layer basis.

The another objective of the present invention is to provide the method for printing a three-dimensional object materials on a layer-by-layer basis, wherein said mixing temperature and the said printing temperature is in the range of 100° C. to 1100° C.

The another main objective of the present invention is to provide a method for beat treating a three-dimensional object with composite metal materials wherein a heating cycle comprises the step of heating said three-dimensional object for an extended period at several temperatures above the melting point of a low melting point material (LTM) but below the melting point of a high melting point powdered material (HTMP).

The another objective of the present invention is to provide the method for heat treating a three-dimensional object with composite metal materials, wherein said heating cycle comprises the following steps: a. ramping the temperature to reach a first bold temperature just above the start of melting of the low melting point material; b. Holding the temperature at the first hold temperature for a first holding time, wherein low melting point material starts to alloy with the high melting powdered material to grow lattice structure; c. Ramping the temperature to reach a next hold temperature; d. Holding the temperature at the next hold temperature for a next holding time; and e. Repeating steps c and d for a number of times till to form a wanted composition of alloy is formed.

The another objective of the present invention is to provide the method for heat treating a three-dimensional object with composite metal materials, wherein said temperatures are in the range of 100° C. to 1100° C.

The another objective of the present invention is to provide a composite material comprising a low melting point material (LTM) and a high melting point powdered material (HTMP) for printing a three-dimensional object by a three-dimensional imaging apparatus.

The another objective of the present invention is to provide the composite material, wherein said low melting point material (LTM) and said high melting point powdered material (HTMP) can be a pure metal or an alloy.

The another objective of the present invention is to provide the composite material, wherein said low melting point material (LTM) is selected from the group of Tin, Indium, Bismuth, Zinc, Lead, Cadmium, Thallium, Gallium, Antimony, Magnesium, Silicon, Aluminium, or an alloy of 2 or more of these metals,

The another objective of the present invention is to provide the composite material, wherein said high melting point powdered material (HTMP) is selected from the group of Copper, Iron, Silver, Gold, Titanium, Nickel, Aluminium, Zinc, Vanadium, Chromium, Cobalt, Zirconium, or an alloy between 2 or more of these metals.

The another objective of the present invention is to provide the composite material, wherein said composite material comprises said high melting point powdered material (HTMP) in the range of 30% to 75% by volume.

### (4) BRIEF DESCRIPTION OF THE DRAWINGS

The invention will be better understood and objects other than those set forth above will become apparent when consideration is achieved to the following detailed description thereof. Such description makes reference to the annexed drawings wherein:

FIG. 1 depicts a schematic representation of the three-dimensional imaging apparatus (three-dimensional imaging apparatus (3D-printer)) comprising the print head unit and nozzle, where nozzle is pre-loaded with a supply of material, in accordance with the present invention.

FIG. 2 represents the flow chart of the method of manufacturing 3D objects in accordance with the present invention.

FIG. 3 depicts a schematic arrangement of the composite metal materials before and after applying a heating ramp scheme of the 3D objects in accordance with the present invention.

FIG. 4 depicts a screw pump (print head unit) of the three-dimensional imaging apparatus (three-dimensional imaging apparatus (3D)-printer)), in accordance with the present invention.

FIG. 5 depicts a schematic representation of how 3D-printing is performed using a jetting array using additive manufacturing process, in accordance with the present invention.

FIG. 6 depicts an illustrative temperature ramping scheme used to form alloys of the composite metal materials by three dimension printing, in accordance with the present invention.

FIG. 7 represents a flow chart of a temperature ramping scheme to form alloys of the composite metal materials by three dimension printing, in accordance with the present invention.

### (5) DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense.

The present invention is described in brief with reference to the accompanying drawings. Now, refer in more detail to the exemplary drawings for the purposes of illustrating non-limiting embodiments of the present invention.

As used herein, the term “comprising” and its derivatives including “comprises” and “comprise” include each of the stated integers or elements but does not exclude the inclusion of one or more further integers or elements.

As used herein, the singular forms “a”, “an”, and “the” include plural referents unless the context clearly dictates otherwise. For example, reference to “a device” encompasses a single device as well as two or more devices, and the like.

As used herein, the terms “for example”, “like”, “such as”, or “including” are meant to introduce examples that further clarify more general subject matter. Unless otherwise specified, these examples are provided only as an aid for understanding the applications illustrated in the present disclosure, and are not meant to be limiting in any fashion.

As used herein. the terms “may”“can”, “could” or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated bardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements of limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition and persons in the pertinent art have given that term as reflected in printed publications and issued patents at the time of filing.

Groupings of alternative elements or embodiments of the invention disclosed herein are not to be construed as limitations. Each group member can be referred to and claimed individually or in any combination with other members of the group or other elements found herein. One or more members of a group can be included in. or deleted from, a group for reasons of convenience and/or patentability. When any such inclusion or deletion occurs, the specification is herein deemed to contain the group as modified thus fulfilling the written description of all groups used in the appended claims.

Three-dimensional printing is a process of constructing 3D objects from digitized files. In this process, a 3D object is designed using Solid Works, AutoCAD, and Z-Brush, which are some examples of popular CAD software used commercially. Meshmixer, SketchUP, Blender, and FreeCAD, are some examples of the freeware commonly used to make 3Dobjects. These 3D objects are saved in a 3D printer-readable file format. The most common universal file formats used for 3D printing are STL (stereo lithography) and VRML (virtual reality modeling language). Additive manufacturing file format (AMF), GCode, and ×3 g are some of the other 3D printer readable file formats. In additive manufacturing, material is laid in layer-by-layer fashion in the required shape, until the object is formed. Although the term 3D printing is used as a synonym for additive manufacturing, there are several different fabricating processes involved in this technology. Depending on the 3D printing process, additive manufacturing can be classified into four categories, including extrusion printing, material sintering, material binding, and object lamination.

There is need for a low cost 3d printer for additive manufacturing using metals, metal alloys, and composite metal materials. The main demand for an innovative three-dimensional additive manufacturing apparatus for metals is for engineering prototyping and production of spare parts.

Metal 3D printing is useful for parts that are tricky to machine, either in complexity or material, because especially at low volumes it can be cheaper. Harder materials like stainless steels, tool steels, titanium, and others are more difficult to work with and require higher quality tooling, better machines, and more overhead costs. The added natural manufacturing costs adds to the relative value that 3D printing provides, allowing them to cross the “inflection point” at which 3DP becomes valuable. On the other side of the spectrum, materials that are easy and cheap to machine (low grade steel, aluminum), aren't as in demand because it's already easy to make them. This forms a grouping of “common” metal printing materials that are traditionally really hard to work with. made simple by additive instead of subtractive.

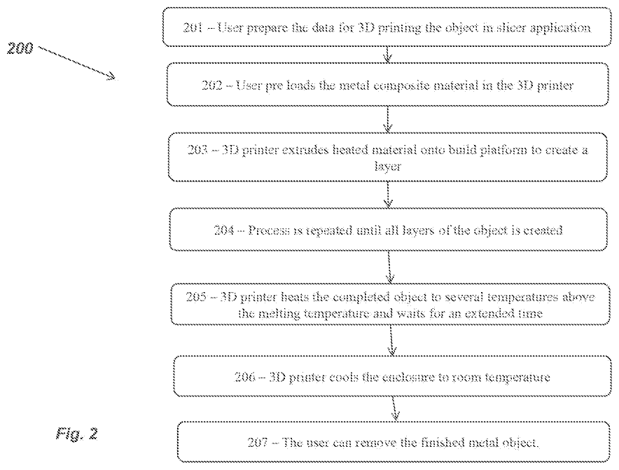

The present invention relates to a three-dimensional imaging apparatus having a print head unit for supplying metal(s) or composite metal materials for three-dimensional object. The three-dimensional imaging apparatus is of low cost as compared to the apparatus available in the market. The three-dimensional imaging apparatus of the present invention provides solution for all the industries or examples given above. The objective of the present invention is to provide a composite metal material for 3D printing with low cost 3D printer equipment. The method of three dimensional printing is also disclosed in detailed. The low cost equipment is similar to existing desktop 3d printers where the resulting metal object can have mechanical, thermal and electrical properties similar to a CNC cut or molded metal part(s). The inventive material of the present invention is a composite of High Temperature Melting point Metal Powder (HTMP) of size 0.1-250 microns, and a Low temperature melting point material (LTM). The first metal can be in the form of powder. The powdered metal can be a metal or a metal alloy with a melting temperature above 300° C. The first type of metals can be Copper, Iron. Silver, Gold, Titanium, Nickel, Aluminium, Zinc. Vanadium, Chromium, Cobalt, Zirconium, in pure form or an alloy between 2 or more of these metals. The second type of metal or metal alloy is selected, which has low melting point below 1100° C. The low meting point materials can be a metal or a metal alloy with a melting temperature below 1100° C., preferably an eutectic alloy or an near eutectic alloy. The metal or metal alloy can be selected from the list of Tin, Indium, Bismuth, Zinc, Lead, Cadmium, Thallium, Gallium, Antimony, Mercury, Magnesium, Silicon, Aluminium, in pure form or an alloy of 2 or more of these metals. The LTM metal can also include an additive in the amount of 0.1% to 5% of the total weight, to modify the rheology while melted. The additive can be a metal powder of nano size. 0.001-1 microns, in metals such as Copper, Iron, Silver, Gold, Titanium, Nickel, Aluminium, Silicon, Zinc, Vanadium, Chromium, Cobalt, Zirconium. The additive can be a non metallic inorganic powder of nano size, 0.001-1 microns, in materials such as Al2O3, SiO2, KNaO, CaO, B2O3, BaO, Cr2O3, Cu2O, CuO, Fe2O3, FeO, K2O, MgO, MnO, MnO2, Na2O, NiO, TiN, TiCN, TiC, B4C, SiC, MoSi2, BN, C. The LTM metal can also include an metal additive in the amount of 0.05% to 5% of the total weight, to improve the wetting ability towards the chosen HTMP. The additive can be Silver, Copper, Gold, Indium, Aluminum, Titanium, Nickel, Gallium, Chromium, Cerium. The composite metal material of the present invention is prepared by mixing the powdered metal with the low melting point material at a temperature above the melting point of the low melting point material but below the melting point of the powdered metal. This creates a composite of the two metals. The metals in the composite are not alloyed but instead distinct separated as powdered metal particles embedded in the low meting point metal/metal alloy. The composite metal material of the present invention can then be formed into a 3D printing material in the form of rods or pellets or a filament. The composite metal material can then be formed into a 3D object by a process similar to a fused filament fabrication process, which is explained in detail in FIG. 2.

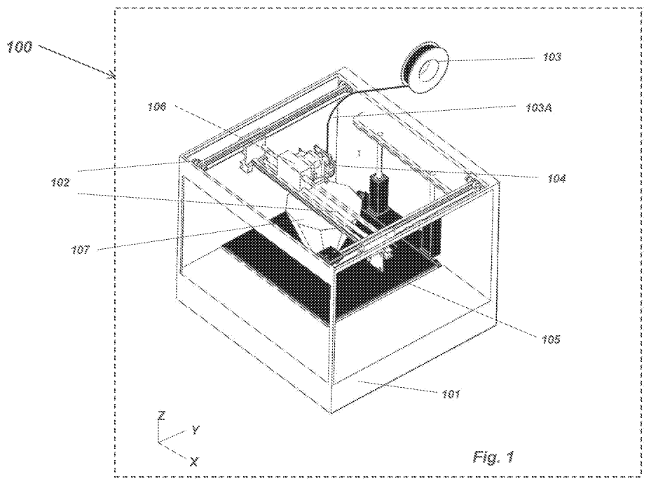

FIG. 1 depicts a schematic representation of the three-dimensional imaging apparatus (three-dimensional imaging apparatus (3D-printer) comprising the print head unit having nozzle, where nozzle is pre-loaded with a supply of material, in accordance with the present invention. The present invention discloses a three-dimensional imaging apparatus 100 for modeling with composite metal materials on a layer-by-layer basis in accordance with a computer aided design (CAD) image of an object, comprising: a printer holding frame 102; a gantry motion system 102; a supply of composite materials 103, wherein said supply of composite materials 103 is configured to supply either a filament or a rod 103A; a print head unit 106, wherein said print head 106 is fixed on said gantry motion system 102: a nozzle 104; a build platform 105 on which said object is printed; wherein said print head unit 106 comprising a feeding arrangement 400A, a heating arrangement 403, and a screw mechanism 400B: wherein said feeding arrangement 400A comprises a motor 401, a plurality of wheels 402, & a coupler 407, wherein said beating arrangement 403 is configured to heat said composite metal materials at a temperature; wherein said screw mechanism 400B comprises a material receiving screw geometry 404, a screw 405, a nozzle head 406; wherein said feeding arrangement 400A is configured to feed either said filament or said rod to said screw mechanism while heating by said heating arrangement 403; and wherein said screw mechanism 400B is configured to extrude said composite materials by said nozzle thru a nozzle head 406 for printing.

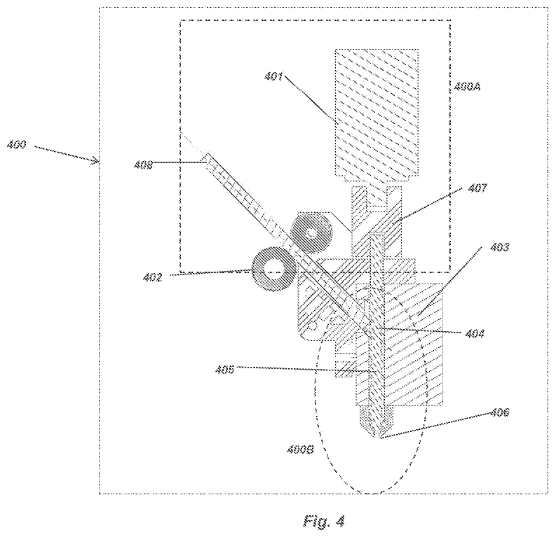

The three-dimensional imaging apparatus (three-dimensional imaging apparatus (3D-printer) 100 comprising a printer holding frame 101, a Gantry motion system (XY gantry) 102, supply of composite metal materials 103, a filament 103A, a nozzle 104, a build platform 105, and a print head unit 106. The 3d printer will build the object by moving the printhead 106 in X-Y plane and extrude heated material to form a layer of the object onto the build plate 105 and sequentially displacing the printhead 106 and the build plate 105 in a third direction (Z direction) orthogonal to the X-Y plane to build the object in a layer by layer manner. The supply of composite metal materials is configured to supply either a filament or a rod. The print head unit 106 is attached on the Gantry motion system (XY gantry) 102. The print head unit 106 can move in X and Y direction by means of Gantry motion system (XY gantry) 102. The supply of filaments 103 is configured to supply material of composite metal material in filament form. The material is pre-loaded into the filament entry point of a nozzle 104. The 3D printed object is depicted as 107. The print head unit can be a heated nozzle with a feedomg wheel driving the filament through the nozzle. The print head unit can be a complex screw pump (print head unit) as depicted in FIG. 4. To improve flow of the molten composite material arrangement for vibrations a vibrator can be added in the print head unit 106. The vibrator can be placed near or within the heating arrangement. The printing process the partly finished object is kept near the melting point of the Low temperature melting point material (LTM) to allow fusing of the newly extruded layer material with the previous layer of the object. This can be achieved by including a beating function of the build plate 105 with thermal connection to the object, or by enclosing the printer bolding frame 101 and heating the inside with a circulating heater. During the printing process the environment around the printing area can be filled or flooded with an inert gas to prohibit oxide build up and enhance layer adhesion.

FIG. 2 represents the flow chart of the method of manufacturing 3D object using the print head unit in accordance with the present invention. A method for printing a three-dimensional object with composite metal materials is also disclosed. The method comprising the following steps. (i) Preparing composite materials by mixing a high melting point powdered material (HTMP) and a low melting point material (LTM) at a mixing temperature above the melting point of said low melting point material (LTM) but below the melting point of said high melting point powdered material (HTMP) and extruding it to form a pellet, a filament, or a rod; (ii) Preloading said filament or said rod of composite metal materials, prepared in step (i), on a supply of composite materials; (iii) Creating an image of a three-dimensional object of composite metal materials by a computer aided design (CAD) tool; (iv) Preparing data for three dimensional printing by said slicer application or by said computer interface based on the information received from step (iii); (v) Communicating said data for said three dimensional printing object from said slicer application or by said computer interface to a three-dimensional printer; (vi) Printing a layer onto a build platform by extruding the heated said composite metal materials, wherein said composite metal materials is heated at temperature above the melting point of a low melting point material (LTM) but below the melting point of a high melting point powdered material (HTMP); and (vii) Repeating step (vi) for printing one layer of the said three-dimensional object by layer-by-layer basis. The mixing temperature and the said printing temperature is in the range of 100° C. to 1100° C. To start the manufacturing process, the user starts the slicer application and prepared the data for 3D printing the object (step 201). In next step 202, the user preloads the required composite metal materials into the three-dimensional imaging apparatus (three-dimensional imaging apparatus (3D-printer)). In next step 203, the three-dimensional imaging apparatus (three-dimensional imaging apparatus (3D-printer)) will extrude the heated material onto build platform for creating the layer. The material is heated to a temperature above the melting point of the low melting point material (LTM) but below the melting point of the powdered metal (HTMP). This will soften the composite supply material enough to allow extrusion and building of the layer, The three-dimensional imaging apparatus (three-dimensional imaging apparatus (3D-printer)) will repeat until all layers are done and 3D-object is printed (step 204). The 3D printer has the arrangement for heating the created 3D object. in next step 205, the 3D printer heats the completed object to a temperature above the melting temperate and waits for an extended time. The finished 3Dobject should be beat treated for an extended period at a temperature above the melting point of the low melting point material but below the melting point of the powdered metal. The heat treatment can be done in the enclosed heated space of the 3d printer or in a separate heat treatment furnace or oven. The heat treatment will convert the composite material into several alloys of the different metal in the composite. Then, the treated 3D object is cooled to the room temperature (step 206). The finished 3D object removed from the 3D printer (step 207). In an alternate embodiment, it is also possible to prepare the 3D object by using the multiple metallic materials or metallic composite materials.

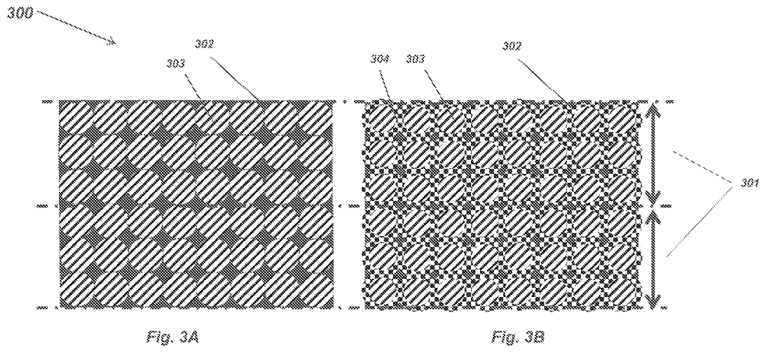

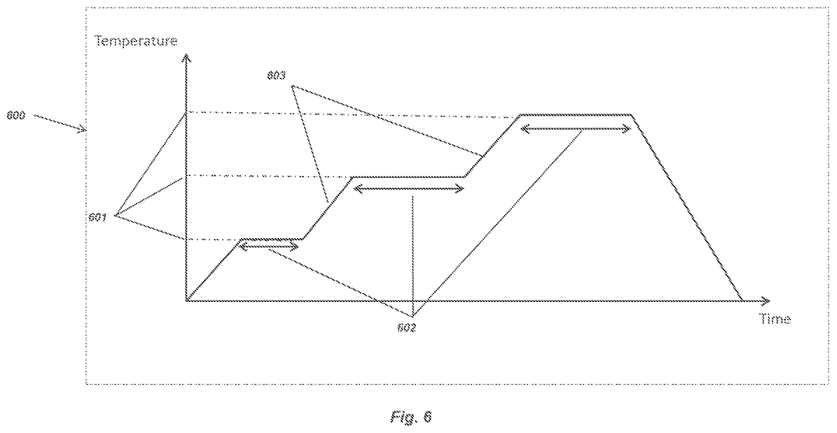

FIG. 3 depicts a schematic arrangement of the composite metal materials before FIG. 3A, and after FIG. 3B, applying a heating scheme to the 3D objects in accordance with the present invention. The cross section 300 of 3D object is depicted in the FIG. 3. The 3D object are formed by layering 3D printing method as explained above. The cross section 300 of 3D object shows the layers 301. The multiple layers 301 has a powdered metal material 303 (metal particles, first metal having higher melting point above 300 ° C., High Temperature melting point Metal Powder—HTMP) and a periphery material 302 is of low melting material (such as Low temperature melting point material (LTM)). After applying the heating scheme to the object the resulting layers include new alloys material 304 where the new alloys connect the HTMP cores in a lattice structure to create a structure that can allow a higher temperature without losing the mechanical integrity of the part, The beating scheme example is depicted in the FIG. 6 and explanation provided below in more detailed. The periphery material 302 can be a Low temperature melting point material (LTM) and the core material 303 can be a high temperature melting point metal powder (HTMP). The low temperature metal (LTM) and the high temperature melting point metal powder (HTMP) are capable of forming alloys. The individual metal powder of the HTMP is capable to react with the individual metals of the LTM to form new alloys with increased temperatures (i.e., melting temperatures) and also further correlates to the percentage level of the HTMP metals alloyed into the LTM metal. In one embodiment of the present invention, the LTM includes a metal that will not alloy with the HTMP components. When the other components of the LTM have formed new alloys with the HTMP, remainder metal in the LTM will be scattered through the object to give specific properties to the finished object. The LTM alloy can be a eutectic alloy or a near eutectic alloy. When the LTM metal components starts to alloy with the HTMP components, the melting point of the remaining unreacted LTM will change due to the shift in composition outside the eutectic point of the original LTM, this can be utilized to increase the mechanical integrity of the part through the heating scheme.

For preparing the composite supply material the HTMP should be added at a ratio of 30-70% by volume to the total volume, where the remainder is the LTM. By having a high enough ratio of the HTMP the composite material will keep its mechanical integrity while building the object layer by layer, and also while performing the heat treatment scheme.

The HTMP can be a pure metal, such as Copper, Iron, Silver, Gold, Titanium, Nickel, Aluminium, Zinc, Vanadium, Chromium, Cobalt, Zirconium, or an alloy between 2 or more of these metals.

The HTMP can be a powdered metal in spherical form such a gas atomized or water atomized powder, or irregular form such as crushed or prepared by chemical reaction. The particle size should be between 0.1-200 microns.

The LTM can be a pure metal, such as Tin, Indium, Bismuth, Zinc, Lead, Cadmium, Thallium, Gallium, Antimony, Magnesium, Silicon, Aluminium, or an alloy of 2 or more of these metals.

When choosing the metals and alloys for a specific composite supply material the melting point of the specific HTMP, which can be a pure metal or an alloy, should be at least 100C higher than the melting point of the specific LTM, which can be a pure metal or an alloy.

The composite material can be prepared by a mixing process and extruded into pellets or rods or filament. The mixing process can be performed in an reducing gas and/or an inert gas.

Examples of composite supply materials and preparation methods:

| | Low | High | | |
|---|---|---|---|---|
| | temperature | Temperature | Mixing/ | |
| | melting point | Melting Point | Reaction | |
| | material(s)/ | Metal Powder | Temper- | Ratio/ |
| Example # | Alloys (LTM) | (HTMP) | ature | Comment |
| 1 | Sn | Cu | 240° C. | HTMP 60% |
| | | | | by volume |
| 2 | 16.5% Sn; | Cu | 95° C. | HTMP 60% |
| | 32.5% Bi; | | | by volume |
| | 51% In | | | |
| 3 | 50% Sn; | Ti | 160° C. | HTMP 60% |
| | 50% Bi | | | by volume |
| 4 | Sn 50%; | Cu 90%, | 160° C. | HTMP 60% |
| | Bi 50% | Sn 10% | | by volume |
| 5 | Sn 50%; | Ti 90%, | 160° C. | HTMP 60% |
| | Bi 50% | Cu 10% | | by volume |
| 6 | Sn 50%; | Ti 50%; | 160° C. | HTMP 60% |
| | Bi 50% | Fe 50% | | by volume |
| 7 | Sn | Ti | 240° C. | HTMP 60% |
| | | | | by volume |
| 8 | Sn | Cu | 140° C. | HTMP 60% |
| | | | | by volume |
| 9 | Al | Ti | 670° C. | HTMP 60% |
| | | | | by volume |
| 10 | Al 90%, | Ti | 590° C. | HTMP 60% |
| | Si 10% | | | by volume |
| 11 | Al 75%, | Cu | 600° C. | HTMP 60% |
| | Cu 25% | | | by volume |

The examples here are illustrative of the needed ratios, and a variation of +/−15% of each material is also of interest, further new combinations of the materials in the mentioned examples are also of interest.

FIG. 4 depicts a screw pump (print head unit) of the three-dimensional imaging apparatus (three-dimensional imaging apparatus (3D-printer)), in accordance with the present invention. The screw pump (print head unit) 400 is an alternative arrangement of the three-dimensional imaging apparatus (three-dimensional imaging apparatus (3D-printer)), which is used to feed the composite material to the nozzle of the three-dimensional imaging apparatus (three-dimensional imaging apparatus (3D-printer)). In an embodiment of the three-dimensional imaging apparatus (three-dimensional imaging apparatus (3D-printer)), the screw pump (print head unit) 400 comprises a motor 401, a plurality of wheels 402, a heating arrangement 403. a material receiving screw geometry 404, a auger screw or a cavity pump screw 405, a nozzle head 406, and a coupler 407. A composite filament or rod 408 is fed to the material receiving screw geometry 404 by using the plurality of wheels 402. The filament form or rod form is fed into a new type of screw pump (print head unit) to create the composite material object. The screw pump (print head unit) 400 has a receiving part of the screw 404, which can cut or scrape the material from the filament or rod and move it down to the auger or progressive cavity pump geometry 405. The pump geometry is capable of mechanically kneading or condition the composite material and increase pressure towards the nozzle extrusion point. To control the extrusion rate the material feeder wheel and the screw pump (print head unit) motor speeds are individually controlled to create the right pressure and feed rate of the pump.

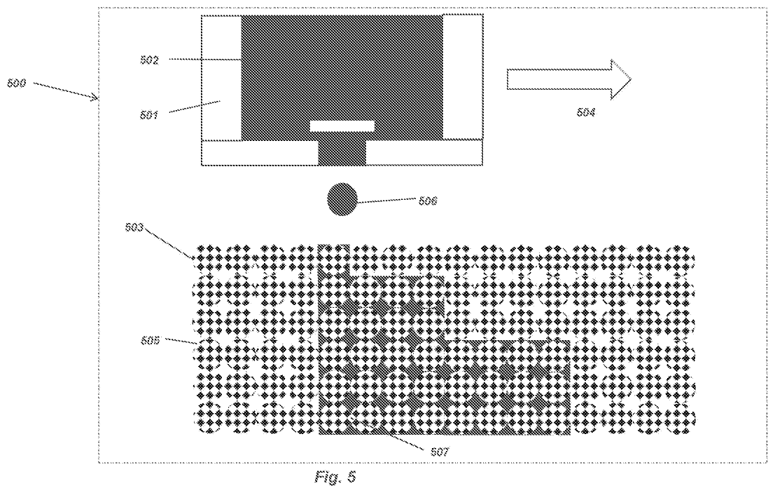

FIG. 5 depicts a schematic representation of how 3D-printing is performed using a jetting array using additive manufacturing process, in accordance with the present invention. Three dimension printing of the composite materials is also possible to print using additive process (or additive manufacturing process) by using an array. The additive manufacturing process 500 is performed by using a jetting array 501, which is moving on a bed 503. The jetting array 502 comprises a plurality of jetting nozzles. The jetting array 501 is fed with the low temperature melting point material (LTM) 502 and is moving in one direction 504. The high temperature melting point metal powder (HTMP) 505 is spread as a powder on the bed 503. The jetting nozzles are jetting droplets 506 of molten LTM metal on the powder of the HTMP 505, when the jetting array 502 moved over the bed 503. As a resultant, the composite material 507 is build up in a specific fashion and creating a 3D-printed object.

In the case where the additive process is as described in FIG. 5 the materials examples are as follows:

| | Low temperature | High Temperature | |
|---|---|---|---|
| | melting point | Melting Point | |
| Example | material(s)/ | Metal Powder | Jetting |
| # | Alloys (LTM) | (HTMP) | Temperature |
| 12 | Sn | Cu | 240° C. |
| 13 | Sn 16.5%; Bi | Cu | 240° C. |
| | 32.5%; In 51% | | |
| 14 | Sn 50%; Bi 50% | Ti | 160° C. |
| 15 | Sn 50%; Bi 50% | Cu 90%; Sn 10% | 160° C. |
| 16 | Sn 50%; Bi 50% | Ti 90%; Sn 10% | 160° C. |
| 17 | Sn 50%; Bi 50% | Ti 50%; Fe 50% | 160° C. |
| 18 | Sn | Ti | 240° C. |
| 19 | Sn 50%; Sn 50% | Cu | 140° C. |
| 20 | Al | Ti | 670° C. |
| 21 | Al 90%, Si 10% | Ti | 590° C. |
| 22 | Al 75%, Cu 25% | Cu | 600° C. |

The examples here are illustrative of the needed ratios, and a variation of +/−15% of each material is also of interest, further new combinations of the materials in the mentioned examples are also of interest. The composite material comprises said high melting point powdered material (HTMP) in the range of 30% to 75% by volume.

A method for beat treating a three-dimensional object with composite metal materials is also exemplified below. The heating cycle comprises the step of heating said three-dimensional object for an extended period at several temperatures above the melting point of a low melting point material (LTM) but below the melting point of a high melting point powdered material (HTMP). The said three-dimensional object can be prepared by any of the mean by using a composite material. The method for heat treating a three-dimensional object with composite metal materials, wherein said heating cycle comprises the following steps: a. ramping the temperature to reach a first bold temperature just above the start of melting of the low melting point material; b. Holding the temperature at the first hold temperature for a first holding time, wherein low melting point material starts to alloy with the high melting powdered material to grow lattice structure: c. Ramping the temperature to reach a next hold temperature; d. Holding the temperature at the next hold temperature for a next holding time; and e. Repeating steps c and d for a number of times till to form a wanted composition of alloy is formed.

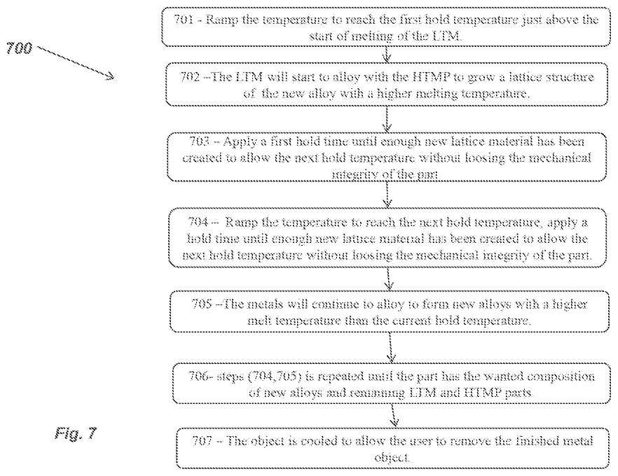

FIG. 6 depicts an illustrative temperature ramping scheme 600 used to transform the composite metal materials prepared by three dimension printing into new alloys, in accordance with the present invention. The illustrative temperature ramping scheme 600 shows the graph of temperature vs. time. Wherein the hold temperature cycle is represented as 601, holding time cycle is represented as 602, and ramping cycle is represented as 603. Further, the detailed manufacturing process is provided in the flow chart, FIG. 7. FIG. 7 represents a flow chart of a process of transforming the 3D object of composite metal materials into the resulting object of new alloys by changing the temperature, in accordance with the present invention. Step 701, ramping the temperature to reach the first hold temperature just above the start of melting of the LTM. During the first hold temperature (step 702), the LTM will start to alloy with the HTMP to grow a lattice structure of the new alloy with a higher melting temperature. At next step 703, apply the first hold time until enough new lattice material has been created to allow a higher temperature without losing the mechanical integrity of the part. In next step 704, ramp the temperature to reach the next bold temperature. At this temperature (step 705) the metals will continue to alloy to form new alloys with a higher melt temperature than the current hold temperature and stronger lattice structures. At the next step 706, if require again steps 704 and 705 are repeated until the part has the wanted composition of alloys and remaining LTM and HTMP parts. Finally, in last step 707, the object is cooled to allow the user to remove the finished metal object.

In one of the example, it is possible to form a composite metal material or binary alloys of Copper and Tin. At the beginning, the Copper particles (powder) will be surrounded by Tin. Now ramp the temperature slowly and reach op to approx. 240° C. after printing. At temperature 240° C., the composite will stay in semi-liquid state. Then, the Tin will be melted and start to alloy with the Copper, and the Copper particles will shrink and “release” Copper into the Tin. At the locations, where the Tin contains more than 40% Copper, it will solidify and form a skeleton structure between the particles. Then, raise the temperature more to grow the skeleton until one can have the desired resulting alloy. The resulting material will most likely contain part with pure tin, and parts with pure copper and the rest an CuSn alloy. This will depend on the temperature curve or the temperature ramping scheme. By having a high enough concentration of powder vs low melt metal it is possible to keep the structural integrity of the part also when the temperature is above the melting point of the low melt metal. By designing the low melt metal as a non-eutectic alloy the structural integrity can be kept during heat treatment by having the temperature at the level where the low melt metal is at a semi liquid/viscous state. There are possibilities of using different combinations of metals and metal alloys to form the composite metal materials, such combinations can be Tin with Bismuth: Iron with Tin; and Copper with Indium. It is also possible to use more than three metals, such as BiSnIn alloy which melts at 85 C and can combine with the Copper or Bronze powder. Experimentations are in progress to find many good combinations of different metals/alloys and the right temperature curves to give the best resulting alloy.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A three-dimensional imaging apparatus for modeling with composite metal materials on a layer-by-layer basis in accordance with a computer aided design (CAD) image of an object, comprising:
A printer holding frame:
A gantry motion system;
A supply of composite materials, wherein said supply of composite materials is configured to supply either a filament or a rod;
A print head unit, wherein said print head unit is fixed on said gantry motion system;
A nozzle:
A build platform on which said object is printed;
Wherein said print head unit comprising a feeding arrangement, a beating arrangement, and a screw mechanism;
Wherein said feeding arrangement comprises a motor, a plurality of wheels, & a coupler;
Wherein said heating arrangement is configured to heat said composite metal materials at a temperature;
Wherein said screw mechanism comprises a material receiving screw geometry, a screw, a nozzle bead;
Wherein said feeding arrangement is configured to feed either said filament or said rod to said screw mechanism while beating by said heating arrangement; and
Wherein said screw mechanism is configured to extrude said composite materials by said nozzle thru a nozzle head for printing.

2. The three-dimensional imaging apparatus for modeling with composite metal materials on a layer-by-layer basis in accordance with a computer aided design (CAD) image of the object as claimed in claim 1, wherein said composite materials is made up of a low melting point material (LTM) and a high melting point powdered material (HTMP).

3. The three-dimensional imaging apparatus for modeling with composite metal materials on a layer-by-layer basis in accordance with a computer aided design (CAD) image of the object as claimed in claim 1, wherein said temperature is above the melting point of said low melting point material (LTM) but below the melting point of said high melting point powdered material (HTMP).

4. The three-dimensional imaging apparatus for modeling with composite metal materials on a layer-by-layer basis in accordance with a computer aided design (CAD) image of the object as claimed in claim 1, wherein said temperature is in the range of 100° C. to 1100° C.

5. The three-dimensional imaging apparatus for modeling with composite metal materials on a layer-by-layer basis in accordance with a computer aided design (CAD) image of the object as claimed in claim 1, wherein said screw is selected from the type of an auger screw or a cavity pump screw.

6. The three-dimensional imaging apparatus for modeling with composite metal materials on a layer-by-layer basis in accordance with a computer aided design (CAD) image of the object as claimed in claim 1, wherein said print head unit further comprises a vibrator.

7. The three-dimensional imaging apparatus for modeling with composite metal materials on a layer-by-layer basis in accordance with a computer aided design (CAD) image of the object as claimed in claim 1, wherein said low melting point material (LTM) and wherein said high melting point powdered material (HTMP) can be a pure metal or an alloy.

8. The three-dimensional imaging apparatus for modeling with composite metal materials on a layer-by-layer basis in accordance with a computer aided design (CAD) image of the object as claimed in claim 1, wherein said low melting point material (LTM) is selected from the group of Tin, Indium, Bismuth, Zinc, Lead, Cadmium, Thallium, Gallium, Antimony, Magnesium, Silicon, Aluminium, or an alloy of 2 or more of these metals.

9. The three-dimensional imaging apparatus for modeling with composite metal materials on a layer-by-layer basis in accordance with a computer aided design (CAD) image of the object as claimed in claim 1, wherein said high melting point powdered material (HTMP) is selected from the group of Copper, Iron, Silver, Gold, Titanium, Nickel, Aluminium, Zinc, Vanadium, Chromium, Cobalt, Zirconium, or an alloy between 2 or more of these metals.

10. A method for printing a three-dimensional object with composite metal materials, wherein said method comprising the following steps:
(i) Preparing composite materials by mixing a high melting point powdered material (HTMP) and a low melting point material (LTM) at a mixing temperature above the melting point of said low melting point material (LTM) but below the melting point of said high melting point powdered material (HTMP) and extruding it to form a pellet, a filament, or a rod;
(ii) Preloading said filament or said rod of composite metal materials, prepared in step (i), on a supply of composite materials;
(iii) Creating an image of a three-dimensional object of composite metal materials by a computer aided design (CAD) tool;
(iv) Preparing data for three dimensional printing by said slicer application or by said computer interface based on the information received from step (iii);
(v) Communicating said data for said three dimensional printing object from said slicer application or by said computer interface to a three-dimensional printer;
(vi) Printing a layer onto a build platform by extruding the heated said composite metal materials, wherein said composite metal materials is heated at temperature above the melting point of a low melting point material (LTM) bot below the melting point of a high melting point powdered material (HTMP); and
(vii) Repeating step (vi) for printing one layer of the said three-dimensional object by layer-by-layer basis, and
(viii) Heat treating a three-dimensional object prepared in step (vii) with composite metal materials wherein a heating cycle comprises the step of heating said three-dimensional object for an extended period at several temperatures above the melting point of a low melting point material (LTM) but below the melting point of a high melting point powdered material (HTMP).

11. The method for heat treating a three-dimensional object with composite metal materials as claimed in claim 10, wherein said heating cycle comprises the following steps:
a. ramping the temperature to reach a first hold temperature just above the start of melting of the low melting point material;
b. Holding the temperature at the first hold temperature for a first holding time, wherein low melting point material starts to alloy with the high melting powdered material to grow lattice structure;
c. Ramping the temperature to reach a next hold temperature;
d. Holding the temperature at the next hold temperature for a next holding time; and
e. Repeating steps c and d for a number of times till to form a wanted composition of alloy is formed.

12. The method for heat treating a three-dimensional object with composite metal materials as claimed in claim 10, wherein said temperatures are in the range of 100° C. to 1100° C.

13. A composite material comprising a low melting point material (LTM) and a high melting point powdered material (HTMP) for printing a three-dimensional object by a three-dimensional imaging apparatus.

14. The composite material as claimed in claim 13, wherein said low melting point material (LTM) and said high melting point powdered material (HTMP) can be a pure metal or an alloy.

15. The composite material as claimed in claim 13, wherein said low melting point material (LTM) is selected from the group of Tin, Indium, Bismuth, Zinc, Lead, Cadmium, Thallium, Gallium, Antimony, Magnesium, Silicon, Aluminium, or an alloy of 2 or more of these metals.

16. The composite material as claimed in claim 13, wherein said high melting point powdered material (HTMP) is selected from the group of Copper, Iron, Silver, Gold, Titanium, Nickel, Aluminium, Zinc, Vanadium, Chromium, Cobalt, Zirconium, or an alloy between 2 or more of these metals.

17. The composite material as claimed in claim 13, wherein said composite material comprises said high melting point powdered material (HTMP) in the range of 30% to 75% by volume.
